(19) United States
(12) Patent Application Publication
(10) Pub. No.: US 2024/0199945 A1
(43) Pub. Date: Jun. 20, 2024

(54) UNWASHED FRAC SANDS FOR HYDRAULIC FRACTURING FLUIDS

(71) Applicant: EOG RESOURCES, INC., Houston, TX (US)

(72) Inventors: Oscar Bustos, San Antonio, TX (US); Matthew Groves, Houston, TX (US); David R. Pyles, Boulder, CO (US)

(73) Assignee: EOG RESOURCES, INC., Houston, TX (US)

(21) Appl. No.: 18/285,735

(22) PCT Filed: Apr. 7, 2022
(86) PCT No.: PCT/US2022/023806

§ 371 Date: Oct. 5, 2023

Related U.S. Application Data
(60) Provisional application No. 63/171,667, filed on Apr. 7, 2021.

(51) Int. Cl. C09K 8/62; C09K 8/80; E21B 43/26; E21B 43/267

(52) U.S. Cl. CPC C09K 8/62; C09K 8/80; E21B 43/2607; E21B 43/267

(57) ABSTRACT

A system for stimulating a well extending through a subterranean earthen formation includes a storage tank including a base fluid, a storage container including an unwashed silica frac sand, a mixing unit in fluid communication with the storage tank, wherein the mixing unit is configured to mix the base fluid from the storage tank with the unwashed silica frac sand from the storage container to produce a fracturing fluid, and a pump configured to pressurize the fracturing fluid and inject the fracturing fluid into the well to form a fracture within the earthen formation.

### CROSS-REFERENCE TO RELATED APPLICATIONS

The present application claims benefit of U.S. provisional patent application No. 63/171,667 filed Apr. 7, 2021, entitled “Unwashed Frac Sands for Hydraulic Fracturing Fluids,” which are incorporated herein by reference in their entirety for all purposes.

### STATEMENT REGARDING FEDERALLY SPONSORED RESEARCH OR DEVELOPMENT

Not applicable.

### BACKGROUND

Hydrocarbons may be recovered from subterranean earthen formations by drilling a well through the earthen formation and establishing fluid communication between the well and the earthen formation. In some applications, the earthen formation may be stimulated to enhance fluid conductivity between the well and the earthen formation. For example, a well stimulation or hydraulic fracturing system may be employed to initiate and propagate hydraulic fractures in the earthen formation extending from the well in order to enhance fluid conductivity between the well and the surrounding formation. Particularly, a hydraulic fracturing fluid may be pumped down the well and into a desired location of the earthen formation via perforations formed in a casing string lining a wall of the well. The fracturing fluid is pressurized to a degree sufficient to initiate one or more fractures at the location along the formation. In some applications, the fracturing fluid includes proppant, such as naturally occurring sand, to prevent the hydraulic fracture from closing following the conclusion of the hydraulic fracturing operation.

### SUMMARY

An embodiment of a system for stimulating a well extending through a subterranean earthen formation comprises a storage tank comprising a base fluid, a storage container comprising an unwashed silica frac sand, a mixing unit in fluid communication with the storage tank, wherein the mixing unit is configured to mix the base fluid from the storage tank with the unwashed silica frac sand from the storage container to produce a fracturing fluid, and a pump configured to pressurize the fracturing fluid and inject the fracturing fluid into the well to form a fracture within the earthen formation. In some embodiments, the frac sand is comprised of between 1.5% and 10% of clay minerals by percent volume. In some embodiments, a sorting index (ϕ1) of the frac sand is between 0.50ϕ units and 0.80ϕ units. In certain embodiments, the frac sand includes between 300 million and 700 million particles per pound. In certain embodiments, the frac sand is comprised of between 25% and 30% of grains having an American Society for Testing (ASTM) mesh size greater than 141 ASTM mesh. In some embodiments, the frac sand has a turbidity equal to or greater than 260 Nephelometric Turbidity Units (NTUs). In some embodiments, the fracturing fluid does not comprise a ceramic proppant.

An embodiment of a system for stimulating a well extending through a subterranean earthen formation comprises a storage tank configured to store a base fluid, a storage container comprising a silica frac sand, a mixing unit in fluid communication with the storage tank, wherein the mixing unit is configured to mix the base fluid from the storage tank with the frac sand from the storage container to produce a fracturing fluid, and wherein the frac sand is comprised of between 1.5% and 10% of clay minerals by percent volume, and a pump configured to pressurize the fracturing fluid and inject the fracturing fluid into the well to form a fracture within the earthen formation. In some embodiments, the frac sand is unwashed. In some embodiments, a sorting index (ϕ1) of the frac sand is between 0.50ϕ units and 0.80ϕ units. In certain embodiments, the frac sand includes between 300 million and 700 million particles per pound. In certain embodiments, the frac sand is comprised of between 25% and 30% of grains having an American Society for Testing (ASTM) mesh size greater than 141 ASTM mesh. In some embodiments, the frac sand has a turbidity equal to or greater than 260 Nephelometric Turbidity Units (NTUs). In some embodiments, the fracturing fluid does not comprise a ceramic proppant.

An embodiment of a method for forming a fracture in a subterranean earthen formation comprises (a) mixing by a mixing unit a base fluid with an unwashed silica frac sand to produce a fracturing fluid, (b) pressurizing by a pump the fracturing fluid produced by the mixing unit, and (c) injecting the pressurized fracturing fluid into a well extending through the earthen formation to form a fracture within the earthen formation. In some embodiments, the frac sand is comprised of between 1.5% and 10% of clay minerals by percent volume. In some embodiments, a sorting index (ϕ1) of the frac sand is between 0.50 ϕ units and 0.80 ϕ units. In certain embodiments, the frac sand includes between 300 million and 700 million particles per pound. In certain embodiments, the frac sand has a turbidity equal to or greater than 260 Nephelometric Turbidity Units (NTUs).

### BRIEF DESCRIPTION OF THE DRAWINGS

For a detailed description of exemplary embodiments of the disclosure, reference will now be made to the accompanying drawings in which:

FIG. 1 is a schematic view of a system for stimulating a subterranean earthen formation according to some embodiments;

FIG. 2 is a schematic view of a sand plant of the system of FIG. 1 according to some embodiments;

FIG. 3 is a graph illustrating cumulative percent volume of grain sizes for a washed sand and an unwashed sand according to some embodiments;

FIG. 4 is a graph illustrating percent by volume of grain sizes for the washed sand and the unwashed sand of FIG. 3;

FIG. 5 is a graph illustrating cumulative percent volume of grain sizes for another unwashed sand according to some embodiments;

FIG. 6 is a graph illustrating percent by volume of grain sizes for the unwashed sand of FIG. 5;

FIG. 7 is a graph illustrating cumulative percent by volume of grain sizes for a plurality of washed and unwashed frac sands;

FIGS. 8-10 are bar graphs illustrating sum percentages of particles by binned ASTM mesh grain size for washed and unwashed frac sands;

FIG. 11 is a bar graph illustrating millions of particles per pound by binned ASTM mesh grain size for the washed and unwashed frac sands of FIGS. 8-10;

FIG. 12 is a schematic view of well system of the system of FIG. 1 according to some embodiments;

FIG. 13 is a schematic view of a fracture network producible by the well system of FIG. 7 according to some embodiments;

FIG. 14 is a zoomed-in schematic view of the fracture network of FIG. 13;

FIG. 15 is a schematic view of dune formed in the fracture network of FIG. 13;

FIG. 16 is a zoomed-in view of the dune of FIG. 15;

FIG. 17 is a schematic view of an experimental apparatus for simulating a fracture network;

FIG. 18 is a graph illustrating flow of a fracturing fluid through the apparatus of FIG. 17;

FIG. 19 is a graph illustrating dune area within a slot cell assembly of the apparatus of FIG. 17 as a function of time;

FIG. 20 is a graph illustrating percent by volume of grain sizes for washed and unwashed frac sands;

FIG. 21 is another graph illustrating dune area within a slot cell assembly of the apparatus of FIG. 17 as a function of time;

FIG. 22 is a graph illustrating percent by volume of grain sizes for an unwashed frac sand; and

FIG. 23 is a graph illustrating percent by volume of grain sizes for another unwashed frac sand; and

FIG. 24 is a flowchart illustrating a method for forming a fracture in a subterranean earthen formation.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis. Any reference to up or down in the description and the claims is made for purposes of clarity, with “up”, “upper”, “upwardly”, “uphole”, or “upstream” meaning toward the surface of the borehole and with “down”, “lower”, “downwardly”, “downhole”, or “downstream” meaning toward the terminal end of the borehole, regardless of the borehole orientation.

As described above, well stimulation operations, such as hydraulic fracturing operations, may be employed to enhance fluid conductivity between a well and a subterranean earthen formation through which the well extends. As part of a hydraulic fracturing operation, a fracturing or “frac” fluid may be injected into the earthen formation from the well whereby fractures extending from the well are formed in the earthen formation. The fractures may comprise primary fractures in the nearfield extending from the well, and dendritic or secondary fractures in the far field which extend from the primary fractures. In this configuration, fluids within the earthen formation may travel into the secondary fractures, through the primary fractures connected to the secondary fractures, and into the well from the primary fractures extending therefrom.

In some applications, the fracturing fluid may include a carrier fluid and particulate solids or proppant suspended within the carrier fluid to prevent the fractures from closing following the conclusion of the hydraulic fracturing operation. Specifically, the particulate solids may be deposited in the fractures as they are formed by the fracturing fluid to thereby prevent the fractures from fully closing. In some applications, the particulate solids comprise naturally occurring “frac sand” such as silica sand which may be mined from suitable deposits and which is typically more economical than man-made proppants such as ceramics. Following mining, the sand is typically cleaned in a washing plant to remove clays, silt, and other fine particulates from the sand and thereby reduce the turbidity of the sand such that it complies with pertinent specifications such as the American Petroleum Institute's (API's) Recommended Practice 19C.

The washed sand may be stacked in piles outside to allow the wash water to drain therefrom. After washing, the sand is typically dried in an air drier to remove moisture from the sand. The dried sand may then be sieved to separate the grains of the sand by their particle size (e.g., American Society for Testing (ASTM) mesh size) such that a plurality of differently sized frac sands may be obtained, each frac sand comprising a narrow distribution of grain sizes. For instance, following sieving, 90% of the grains of frac sand marketed as 70/140 ASTM mesh may fall within the marketed ASTM mesh size (70/140 ASTM mesh in this example). The screened frac sand may then be transported by rail and/or truck to a well site where it may be added to a fracturing fluid for injection into a well of the well site. Grain sizes are referred to herein both by ASTM mesh size and by micrometers or microns (μm). It is important to note that ASTM mesh size is negatively correlated with μm such that, for example, a grain having a 100 ASTM mesh grain size is larger than a grain having a 200 ASTM mesh grain size. For the sake of consistency, when a grain is referred to herein as having a grain size larger than a given ASTM mesh size (e.g., a grain having a grain size larger than 100 ASTM mesh), what is meant is that the ASTM mesh size of the referred to grain is less than the given ASTM mesh size (e.g., the grain has an ASTM mesh size that is 99 ASTM mesh or less than the given 100 ASTM mesh size in this example).

It has conventionally been believed that clays, silt, and other fine particles must be removed from the frac sand prior to its injection into the well in order to prevent the fine particulates from clogging or screening-out the fractures, thereby preventing formation fluids from flowing into the well via the fractures extending therefrom. However, washing processes to remove fine particulates from the sand substantially increases the costs associated with processing the sand following its extraction via mining. Particularly, a relatively expensive washing plant must be provided in which the sand is to be washed. In addition to the capital costs associated with providing a washing plant, additional operating costs also arise due to the increased volume of water as well as additional drying needs, which result from operating the washing plant. In addition to increased investment and operating costs, washed frac sand may also be susceptible to relatively rapid flowback from the formation and into the well during the production phase, limiting the production lifespan of the completed well.

The elimination of the washing plant, in addition to eliminating the additional capital and operating costs associated with the washing plant may also mitigate the environmental impact associated with the sand mining operation. Particularly, given that the usage of water is minimized, the power requirement and attendant greenhouse gas (GHG) and carbon dioxide emissions associated with the drying process following washing is minimized. One other advantage of eliminating the washing plant is a concomitant reduction in the residues or reject sand produced by the sand mining operation.

Embodiments disclosed herein include systems for stimulating a subterranean earthen formation and which may include a storage tank comprising a base fluid, a storage container comprising an unwashed silica frac sand, a mixing unit in fluid communication with the storage tank, wherein the mixing unit is configured to mix the base fluid from the storage tank with the unwashed silica frac sand from the storage container to produce a fracturing fluid, and a pump configured to pressurize the fracturing fluid and inject the fracturing fluid into a well extending through the earthen formation to form a fracture within the earthen formation. Embodiments disclosed herein also include methods for stimulating a subterranean earthen formation which may include mixing by a mixing unit a base fluid with an unwashed silica frac sand to produce a fracturing fluid, pressurizing by a pump the fracturing fluid produced by the mixing unit, and injecting the pressurized fracturing fluid into a well extending through the earthen formation to form a fracture within the formation. As used herein, the term “unwashed silica frac sand” or “unwashed frac sand” is defined as meaning silica frac sand which has not been washed such as by a washing plant or other mechanism to remove clays, silts, fines, or other small particles from the silica franc sand.

Unwashed silica frac sand described herein allows for sufficient initial fluid conductivity between the fracture and the well to allow for the economical production of hydrocarbons therefrom while also exhibiting a lesser degree of fluid conductivity decline over time following the fracturing of the earthen formation. As will be discussed further herein, mitigation of the loss of fluid conductivity resulting from the use of unwashed frac sand may result from a different dune morphology exhibited by the unwashed frac sand, which leads to greater stability and cohesiveness of the unwashed frac sand deposited in the fracture. Additionally, unwashed silica sand has a wider grain-size distribution than washed sand leading to a longitudinal decrease, in grain size, of the sand in a fracture network. As will be discussed further herein, the larger grains are located proximal to the well and the smaller grains are located distal to the well. The smaller grains, being relatively easier to transport than the larger grains, may provide a means to “prop” open smaller fractures than grains from washed sand. Furthermore, in the region proximal to the well, where small amounts of fine particles may be dispersed within predominantly larger grains, the finer particles, through cohesion, may stabilize the unwashed sand thereby reducing the effects of sediment production in the well. Sediment or sand production is a significant problem in horizontal wells, as it affects the production performance of the horizontal well by blocking sections of the lateral portion of the well, may plugin downhole equipment, and increase the wear and tear of moving parts of the well. Thus, along with minimizing capital and operational costs and reducing environmental impact by eliminating the need to wash the frac sand prior to use, the unwashed frac sand has performance benefits in terms of increased production of hydrocarbons relative to similar but washed frac sand.

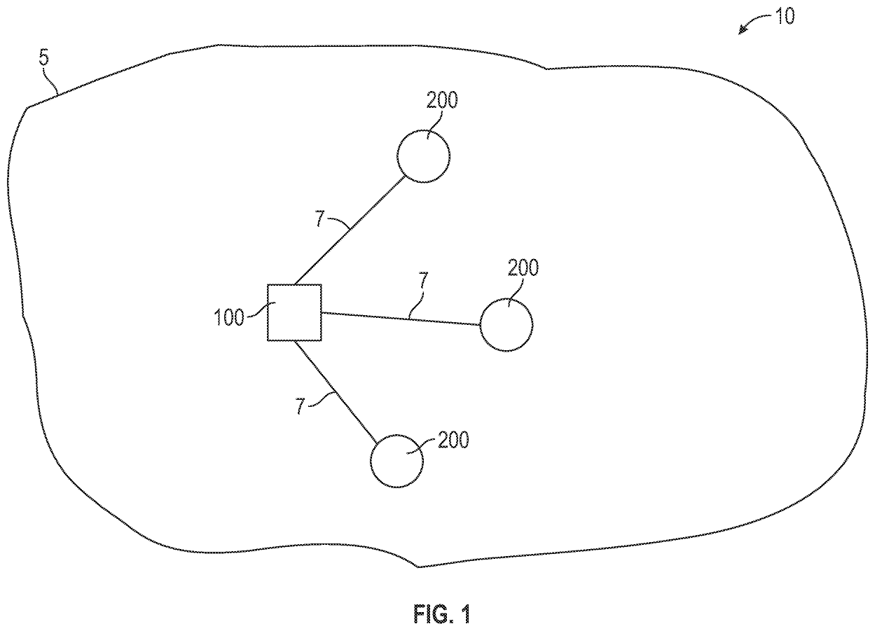

Referring initially to FIG. 1, an embodiment of a system 10 for stimulating a subterranean earthen formation is shown. System 10 may also be referred to herein as a hydraulic fracturing system 10. System 10 generally includes a sand plant 100 and a plurality of well systems 200. As will be described further herein, unwashed naturally occurring sand, such as silica sand, may be extracted from sand plant 100 and transported to the well systems 200 wherein the unwashed sand may be added to a fracturing fluid. In this exemplary embodiment, sand plant 100 and of the plurality of well systems 200 are each positioned within a basin 5. Sand plant 100 is connected to the well systems 200 via a plurality of roads 7 extending therebetween. In this manner, materials extracted from sand plant 100 may be trucked along roads 7 to the well systems 200, eliminating the need for rail transport or shipping. However, in other embodiments, sand plant 100 may not be located within the same basin 5 as well systems 200, and materials extracted from mine 100 may be transported by rail or other conveyance from mine 100 to well systems 200.

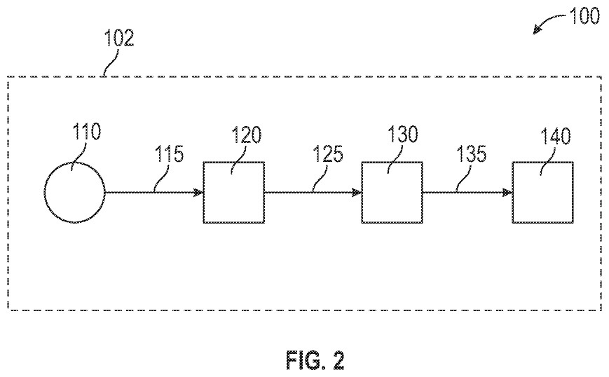

Referring to FIG. 2, an embodiment of the sand plant 100 of system 10 is shown. In this exemplary embodiment, sand plant 100 generally includes a sand mine 110, a dryer system 120, a sieve system 130, and a deployment system 140. In this exemplary embodiment, sand mine 110, dryer system 120, and sieve system 130 are located in proximity to each other at a plant site 102 of the sand plant 100. However, in other embodiments, sand mine 110, dryer system 120, sieve system 130, and deployment system 140 may not be located at the same plant site 102 and instead may be located distal each other at separate and distinct locations.

Sand mine 110 comprises a mine from which naturally occurring, non-man made sand may be extracted for processing in the dryer system 120 and sieve system 130 of sand plant 100. In this embodiment, naturally occurring silica sand may be extracted from sand mine 110; however, in other embodiments, the type of naturally occurring sand extracted from sand mine 110 may vary. The sand produced from sand mine 110 comprises mainly quartz along with other minerals such as clay minerals (including illite, kaolinite, chlorite and smectite) feldspar, calcium carbonate etc. having substantially varying properties including particle or grain size, sphericity, roundness, bulk density, etc.

In this exemplary embodiment, following extraction from sand mine 110, the extracted sand is conveyed via a conveyor 115 from sand mine 110 to the dryer system 120 of sand plant 100. Conveyor 115 may comprise a conveyor belt system or other mechanism configured to transport the extracted sand from sand mine 110 to the dryer system 120. Dryer system 120 may also be referred to herein as a dryer plant 120 and is generally configured to reduce the moisture level of the extracted sand such that the dried sand is prepared for sieving in the sieving system 130. In some embodiments, dryer system 120 generally includes heaters such as thermal rotary dryers and/or other mechanisms for reducing the moisture of the extracted sand supplied to dryer system 120 from sand mine 110.

As discussed above, sand plant 100 does not include a washing system or plant and thus the sand extracted from sand mine 110 is dried in dryer system 120 without first being cleaned or washed in a washing plant or similar mechanism in which moisture is added to the extracted sand in order to separate clays and other fine particulates from the extracted sand and thereby reduce the turbidity of the extracted sand. Instead, the sand extracted from sand mine 110 is transported directly to the dryer system 120 for drying whereby the clay minerals and other silts and fines are preserved within the extracted sand provided to the dryer system 120 rather than being separated out via a washing or cleaning process. By eliminating a washing plant from sand plant 100, the energy required by dryer system 120 for drying the extracted sand may be minimized given the relatively lower moisture content of the extracted sand provided to the dryer system 120. The amount of water required by sand plant 100 may also be minimized by not including a washing plant in sand plant 100, thereby minimizing the environmental impact of sand plant 100.

In this exemplary embodiment, following the drying of the extracted sand in dryer system 120, the dried, unwashed sand is transported by a conveyor 125 to the sieve system 130 which may separate out at least some of the materials of the dried sand based on particle or grain size. Similar to conveyor 115, conveyor 125 may comprise a conveyor belt system or other mechanism configured to transport the extracted sand from dryer system 120 to the sieve system 130. In some embodiments, sieve system 130 generally includes one more screen assemblies such as inclined vibrating gyratory screeners, etc., and/or other mechanisms configured to separate the grain sizes of the dried sand. In this exemplary embodiment, sieve system 130 is configured to only separate out grains having a relatively large grain size that is significantly larger than a median grain size of the dried sand, and to not separate out grains having a grain size that is smaller than a median grain size of the dried sand. For example, for a 100 ASTM mesh sand, sieve system 130 may be configured to separate out sand grains having a grain size that is greater than 70 ASTM mesh. In another example, for a 100 mesh sand, sieve system 130 may be configured to separate out sand grains having a grain size that is greater than 50 ASTM mesh. Thus, sieve system 130 is generally not configured to separate out clay minerals, silts, or other fine particles from the dried sand. In other embodiments, sand plant 100 may not include sieve system 130 and thus the unwashed sand produced by sand plant 100 and utilized by well systems 200 may comprise unwashed and unsieved sand.

In this exemplary embodiment, after the dried sand has been sieved in sieve system 130, the sieved sand is conveyed by conveyor 135 to the deployment system 140 of sand plant 100. Similar to conveyors 115 and 125, conveyor 135 may comprise a conveyor belt system or other mechanism configured to transport the extracted sand from sieve system 130 to the distribution system 140. Distribution system 140 is configured to receive sieved sand from conveyor 135, and to distribute the sand to one or more road-transportable vehicles, such as trucks, for transporting the sieved sand as unwashed frac sand to one or more well systems 200. The unwashed frac sand delivered from sand plant 100 may be used as a proppant in fracturing fluid injected at the one or more well systems 200. In other embodiments, distribution system 140 may be configured to distribute sieved sand to trains, ships, or other modes of transporting the sieved sand from the sand plant 100 to a location remote plant 100.

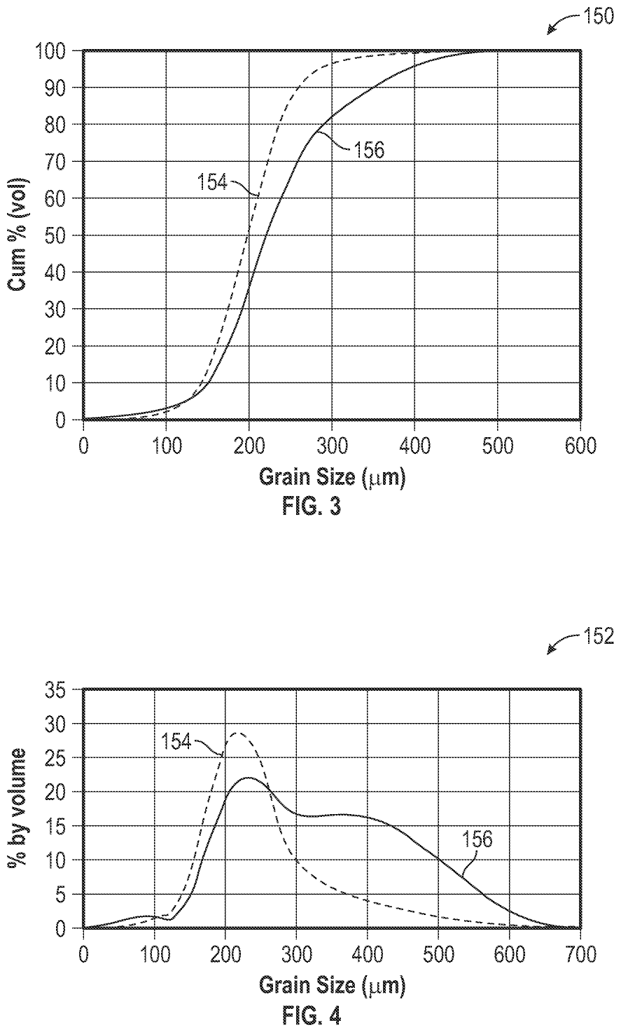

Referring to FIGS. 3, 4, given that frac sand produced by sand plant 100 is unwashed, it has wider distribution of grain sizes than frac sands which are washed. For example, FIGS. 3, 4 illustrate graphs 150, 152, respectively, of an exemplary washed sand 154 and an exemplary unwashed sand 156 sourced from the same sand mine (e.g., sand mine 110 of sand plant 100) or separate sand mines producing similarly naturally occurring sand. In addition to washing, washed sand 154 may be sieved such that washed sand 154v generally comprises 100 ASTM mesh sand. Particularly, exemplary graph 150 of FIG. 3 illustrates cumulative percent (in volume) of the washed sand 154 and unwashed sand 156 as a function of grain size in μm or ASTM mesh size. Additionally, exemplary graph 152 of FIG. 4 illustrates the percent by volume of washed sand 154 and unwashed sand 156 also as a function of grain size in μm.

As shown in graphs 150, 152, unwashed sand 156 has a much greater variance and much wider distribution of grain sizes than washed sand 154. For example, the vast majority of grains comprising washed sand 154 are larger than 100 μm, whereas unwashed sand 156 comprises substantial numbers of grains ranging in size as small as 50 μm. Additionally, unwashed sand 156 includes appreciable amounts (e.g., 1% by volume or greater) of grains having sizes less than 100 μm in size. Further, in this exemplary embodiment, unwashed sand 156 has a turbidity of approximately between 3,000 Nephelometric Turbidity Units (NTUs) and 3,330 NTUs and a cumulative slit and clay content percentage by volume of between approximately 1.4% and 1.8%. Conversely, in this exemplary embodiment, washed sand 154 has a turbidity below approximately 250 NTUs and a cumulative slit and clay content percentage by volume of between approximately 0.6% and 0.8%. Thus, unwashed sand 156, although being sourced from the same or similar materials as washed sand 154, has a dramatically higher turbidity and substantially more slit and clay than washed sand 154.

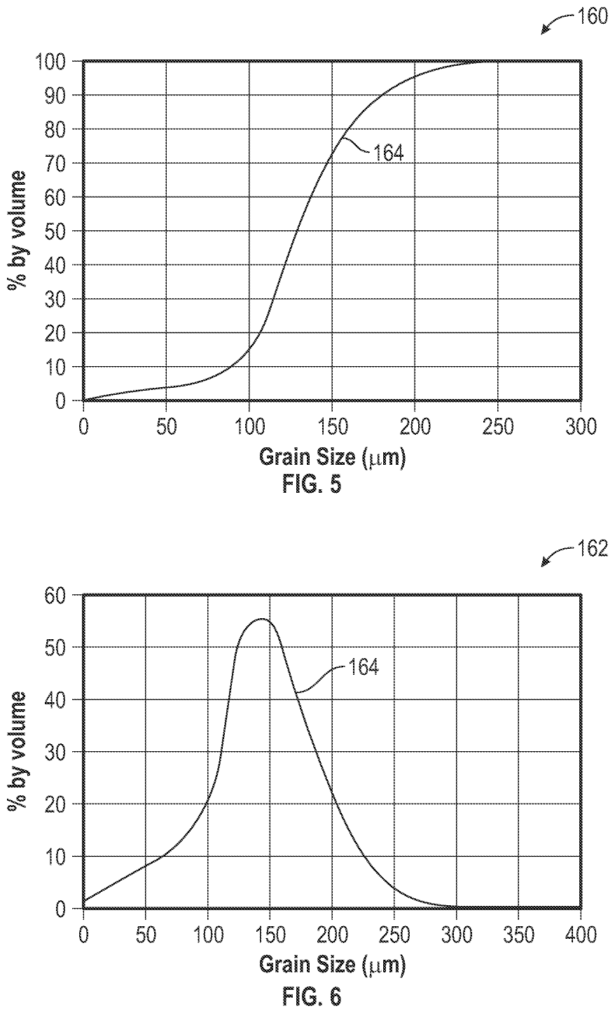

The properties of unwashed sand 156 described above and shown in graphs 150, 152 provide one example of the type of unwashed sand which may be produced from sand plant 100. However, sand plant 100 may provide unwashed frac sand having properties which differ from those of unwashed sand 156. For example, referring to FIGS. 5, 6, graphs 160, 162, respectively, are shown illustrating another exemplary unwashed sand 164. Particularly, exemplary graph 160 of FIG. 5 illustrates cumulative percent (in volume) of unwashed sand 164 as a function of grain size in micrometers (μm). Additionally, exemplary graph 162 of FIG. 6 illustrates the percent by volume of unwashed sand 164 also as a function of grain size in μm. Although the distribution of grain sizes of unwashed sand 164 vary from the distribution of grain sizes of unwashed sand 156, unwashed sand 164 also has a wide distribution of grain sizes including appreciable amounts (e.g., 1% by volume or greater) of grains having sizes less than 100 μm in size. Additionally, unwashed sand 164 has a cumulative slit and clay content percentage by volume of approximately between 1.5% and 2.0%.

It may be understood that properties of unwashed frac sand produced by sand plant 100 and used by one or more of the well systems 200 may vary substantially. For example, properties of unwashed frac sand in fracturing fluid thereof may vary also from the properties of unwashed sand 156 shown in graphs 150, 152, respectively, and unwashed sand 164 shown in graphs 160, 162. The grain size distribution and mineralogy of unwashed sand may exhibit greater variance than comparable washed sand due to the simplified process for producing the unwashed sand relative to the more complicated, expensive process for producing washed sand. For example, properties of unwashed sand 156, shown in graphs 150, 152 respectively, and unwashed sand 164 shown in graphs 160, 162, respectively, vary substantially from each other. The variability exhibited in graphs 150, 152 pertaining to unwashed sand 156, and graphs 160, 162 pertaining to unwashed sand 164, may be due to the simplicity of the processing methods or local changes in grain-size distributions and mineralogy across a given sand mine.

TABLE 1

| | 100 Mesh | | | | | | |
|---|---|---|---|---|---|---|---|
| | Ref | Frac Sand 1 | | Frac Sand 2 | | Frac Sand 3 | |
| | Washed | Washed | Unwashed | Washed | Unwashed | Washed | Unwashed |
| % of Silts | <1.5 | 23.9 | 27.8 | 14.5 | 23.7 | 1.8 | 3.1 |
| and Clays | | | | | | | |
| Sorting | 0.3 | 0.42 | 0.51 | 0.46 | 0.75 | 0.34 | 0.46 |
| Index (ϕ₁) | | | | | | | |
| Skewness | 0.21 | 0.11 | 0.22 | 0.19 | 0.43 | 0.08 | −0.02 |
| (Skᵢ) | | | | | | | |
| Particles | 155 | 265 | 483 | 221 | 631 | 80 | 127 |
| per lb | | | | | | | |
| Turbidity | <250 | 449 | 6219 | 156 | 3231 | 373 | 3385 |

Table 1 shown above illustrates the contrast in properties between several exemplary frac sand types sourced from varying frac sand mines. Particularly, Table 1 illustrates properties of an exemplary 100 ASTM Mesh frac sand that has been washed as a reference standard (100 Mesh Ref). Table 1 additionally illustrates properties of washed and unwashed variants of exemplary Frac Sands 1, 2, and 3, each of which are sourced from a different sand mine. The properties for each Frac Sand 1, 2, and 3 and the 100 ASTM Mesh reference standard include the percentage of silts and clays (particles having a grain size less than 106 μm and an ASTM Mesh size greater than 140), a sorting index (ϕ₁) in units of ϕ, skewness (Skᵢ) in units of ϕ, the number of particles per pound (lb) (in millions) of the given frac sand, and the turbidity in NTUs of the given frac sand.

For example, unwashed Frac Sand 1 includes 1.3% K Feldspar, 2.2% Kaolinite, and 2.2% Illite/Smectite. The amount and types of clay minerals in a given unwashed frac sand may vary depending upon the mine from the unwashed frac sand is extracted from. For example, another unwashed frac sand sourced from a different mine in a different location may comprise 8.9% clay minerals including 8.5% Illite, 0.2% Pyrite, and 0.2% Rutile. In another example, another unwashed frac sand sourced from a different mine in a different location may comprise 1.7% clay minerals including 1.3% K Feldspar, 0.1% Illite, 0.1% Illite/Smectite, and 0.1% Kaolinite.

The sorting index refers to the grain-size variation of each frac sand type shown in Table 1 by encompassing the largest parts of the size distribution of a given frac sand type as measured from a cumulative curve. The sorting index for each frac sand type thus corresponds to an inclusive grain size standard deviation. Not intending to be bound by any particular theory, the ϕ unit represents a logarithmic transformation of grain size in millimeters (mm) into whole integers as indicated in Equation (1) below, where d represents grain diameter in mm:

ϕ=−Log₂ d (1)

Not intending to be bound by any particular theory, the sorting index (ϕ₁) for each frac sand type shown in Table 1 may be computed in accordance with Equation (2) shown below where ϕ95, ϕ84, ϕ16, and ϕ5 represent the grain size (in ϕ units) at the 95th, 84th, 16th, and 5th percentiles of a given frac sand type:

$${ϕ}_{1} = \frac{ϕ 84 - ϕ 16}{4} + \frac{ϕ 95 - ϕ 5}{6.6} \qquad ( 2 )$$

Typically, a frac sand having a sorting index (ϕ₁) less than 0.35 is referred to as very well sorted; frac sand having a sorting index (ϕ₁) of 0.35-0.50 is referred to as well sorted; frac sand having a sorting index (ϕ₁) of 0.50-0.71 is referred to as moderately well sorted; frac sand having a sorting index (ϕ₁) of 0.71-1.00 is referred to as moderately sorted; frac sand having a sorting index (ϕ₁) of 1.00-2.00 is referred to as poorly sorted; frac sand having a sorting index (ϕ₁) of 2.00-4.00 is referred to as very poorly sorted; and frac sand having a sorting index (ϕ₁) greater than 4.00 is referred to as extremely poorly sorted.

Skewness (Skᵢ) refers to the degree at which a cumulative curve corresponding to a grain size distribution of a given frac sand approaches symmetry. Thus, a frac sand having a perfectly symmetrical grain size distribution curve will have a skewness (Skᵢ) equal to zero. Not intending to be bound by any particular theory, the skewness (Skᵢ) for each frac sand type shown in Table 1 may be computed in accordance with Equation (3) shown below where ϕ95, ϕ84, ϕ50, ϕ16, and ϕ5 represent the grain size (in ϕ units) at the 95th, 84th, 50th, 16th, and 5th percentiles of a given frac sand type:

$$S {k}_{i} = \frac{ϕ 16 + ϕ 84 - 2 ϕ 50}{2 ( ϕ 84 - ϕ 16 )} + \frac{ϕ 5 + ϕ 92 - 2 ϕ 50}{2 ( ϕ 95 - ϕ 5 )} \qquad ( 3 )$$

A frac sand having a relatively large proportion of fine particles is positively skewed whereas a frac sand having a relatively large proportion of coarse particles is negatively skewed. A frac sand having a skewness (Skᵢ) from +0.10 to −0.10 is referred to as nearly symmetrical; a frac sand having a skewness (Skᵢ) from −0.10 to −0.30 is referred to as coarse-skewed; a frac sand having a skewness (Skᵢ) from −0.30 to −1.00 is referred to as strongly coarse-skewed; a frac sand having a skewness (Skᵢ) from +0.10 to +0.30 is referred to as fine-skewed; and a frac sand having a skewness (Skᵢ) from +0.30 to +1.00 is referred to as strongly fine-skewed. A given frac sand may be well sorted and strongly skewed and vice-a-versa.

As shown above in Table 1, the unwashed variant of each Frac Sand 1, 2, and 3, is more poorly sorted (having a greater sorting index (ϕ₁) than the corresponding washed variant of the Frac Sand 1, 2, and 3, respectively. Additionally, the unwashed variant of each Frac Sand 1, 2, and 3, has a substantially greater number of particles per pound compared to the corresponding washed variant of the Frac Sand 1, 2, and 3, respectively. Further, the unwashed variant of each Frac Sand 1, 2, and 3, has a substantially greater turbidity compared to the corresponding washed variant of the Frac Sand 1, 2, and 3, respectively.

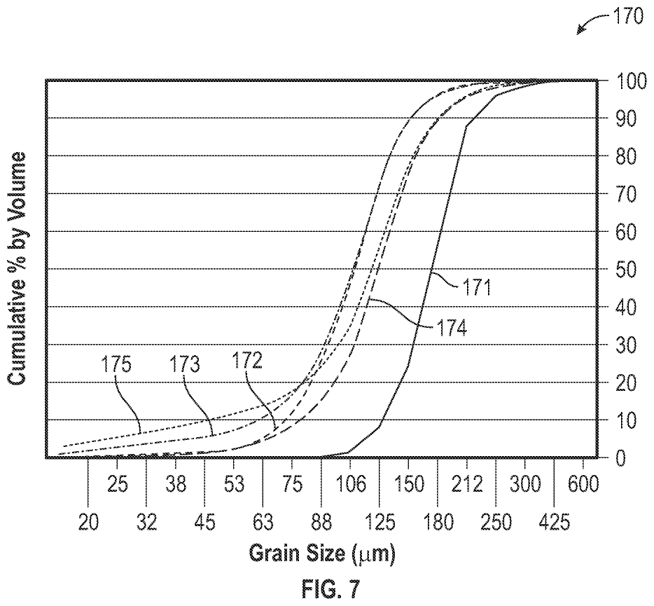

Referring to FIG. 7, a graph 170 is shown illustrating cumulative percent (in volume) of Frac Sands 1, 2, and 3 as a function of grain size in μm. Particularly, graph 170 illustrates the 100 reference standard 171, the washed 172 and unwashed variants 173 of Frac Sand 1, and the washed 174 and unwashed variants 175 of Frac Sand 2. As shown in graph 170, approximately 90% of the particle size distribution of the 100 ASTM mesh reference standard 171 falls between 106 μm and 212 μm (i.e., between 70 ASTM mesh and 140 ASTM mesh) whereas the unwashed variants 173, 175 of Frac Sands 1, 2, respectively, have a significantly wider particle size distribution than reference standard 171. Moreover, the unwashed variants 173, 175 of Frac Sands 1, 2, respectively, have a wider particle size distribution than the corresponding washed variants 172, 174 of Frac Sands 1, 2.

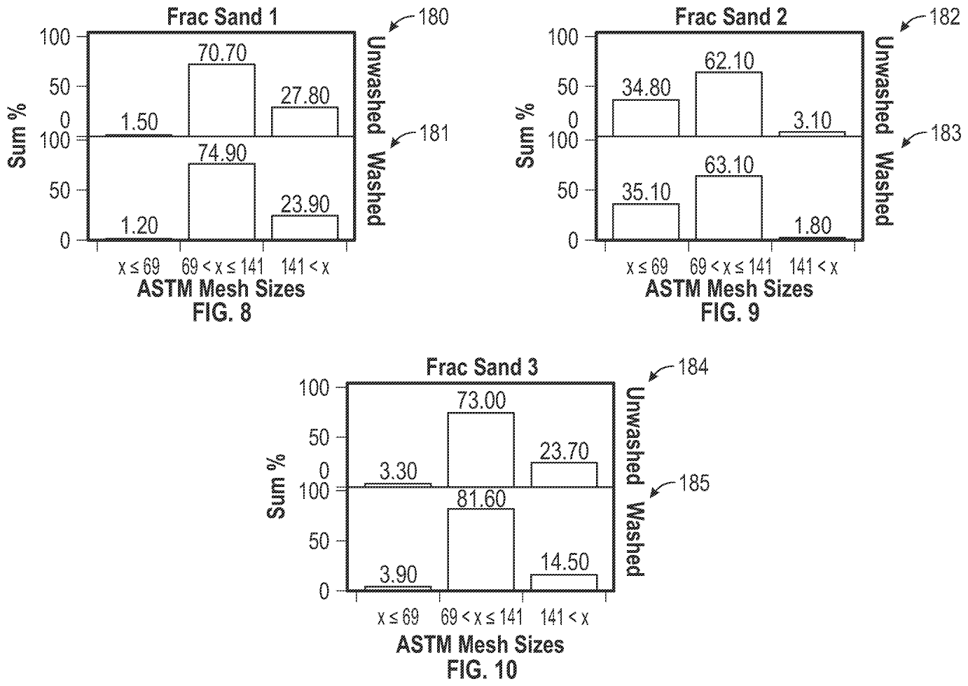

Referring to FIGS. 8-10, bar graphs 180-185 are shown illustrating the number of particles by sum percentage of Frac Sands 1 (FIG. 8), 2 (FIG. 9), and 3 (FIG. 10) as a function of binned ASTM mesh size. Particularly, each bar graph 180-185 illustrates the sum percentage for particles having an ASTM mesh size of equal to or less than 69. Particles having an ASTM mesh size of equal to or less than 141 and greater than 69, and particles having an ASTM mesh size of greater than 141. Bar graphs 180, 181 pertain to the unwashed (bar graph 180) and washed (bar graph 181) variants of Frac Sand 1; bar graphs 182, 183 pertain to the unwashed (bar graph 182) and washed (bar graph 183) variants of Frac Sand 2; and bar graphs 184, 185 pertain to the unwashed (bar graph 184) and washed (bar graph 185) variants of Frac Sand 3. As shown in bar graphs 180-185, the sum percentage of particles having an ASTM mesh size of greater than 141 is significantly higher in the unwashed variants 180, 182, 184 as of Frac Sands 1, 2, and 3, respectively, compared to the corresponding washed variants 181, 183, and 185, respectively.

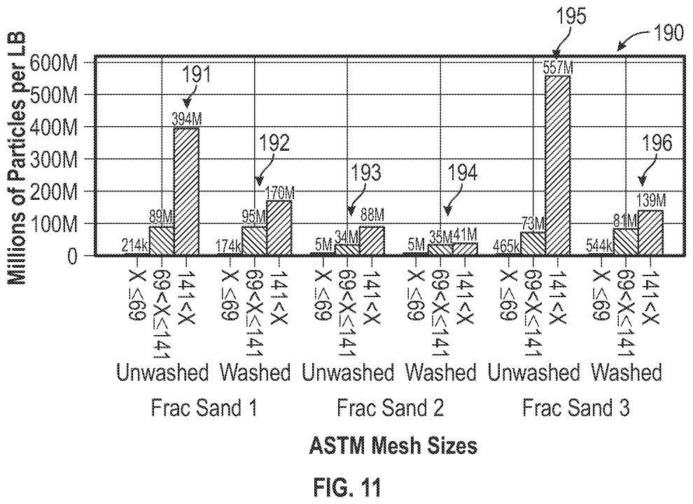

Referring to FIG. 11, a graph 190 is shown illustrating millions of particles per lb of Frac Sands 1, 2, and 3 as a function of binned ASTM mesh size. Particularly, graph 190 includes a plurality of bar graphs 191-196 where each bar graph 191-196 illustrates the millions of particles per pound having an ASTM mesh size of equal to or less than 69, particles having an ASTM mesh size of equal to or less than 141 and greater than 69, and particles having an ASTM mesh size of greater than 141. Bar graphs 191, 192 pertain to the unwashed (graph 191) and washed (graph 192) variants of Frac Sand 1; bar graphs 193, 194 pertain to the unwashed (graph 193) and washed (graph 194) variants of Frac Sand 2; and bar graphs 195, 196 pertain to the unwashed (graph 195) and washed (graph 196) variants of Frac Sand 3. Bar graphs 191-196 demonstrate that the unwashed variants 191, 193, and 195 variants of Frac Sands 1, 2, and 3, respectively, have a significantly greater number of particles per LB of ASTM mesh size 141 or greater than the corresponding variants 192, 194, and 196, respectively.

As described above, the parameters of a given unwashed frac sand may vary depending upon the mine from which the unwashed frac sand is sourced. In some embodiments, the unwashed frac sand produced by sand plant 100 and utilized in the fracturing fluid of one or more of well systems 200 has a sorting index (ϕ₁) of approximately between 0.50ϕ units and 0.80ϕ units. In some embodiments, the unwashed frac sand produced by sand plant 100 and utilized in the fracturing fluid of one or more of well systems 200 has a Skewness (Skᵢ) of approximately between 0.20ϕ units and 0.50ϕ units. In some embodiments, the unwashed frac sand produced by sand plant 100 and utilized in the fracturing fluid of one or more of well systems 200 includes approximately between 300 and 700 million particles per pound. In some embodiments, the unwashed frac sand produced by sand plant 100 and utilized in the fracturing fluid of one or more of well systems 200 has a turbidity equal to or greater than 260 NTUs. In some embodiments, the unwashed frac sand produced by sand plant 100 and utilized in the fracturing fluid of one or more of well systems 200 is comprised of between 1.5% and 10% of clay minerals by percent volume and between 90% and 98% of quartz minerals by percent volume. In some embodiments, the unwashed frac sand produced by sand plant 100 and utilized in the fracturing fluid of one or more of well systems 200 is comprised of between 1.5% and 3% of clay minerals by percent volume and between 95% and 98% of quartz minerals by percent volume.

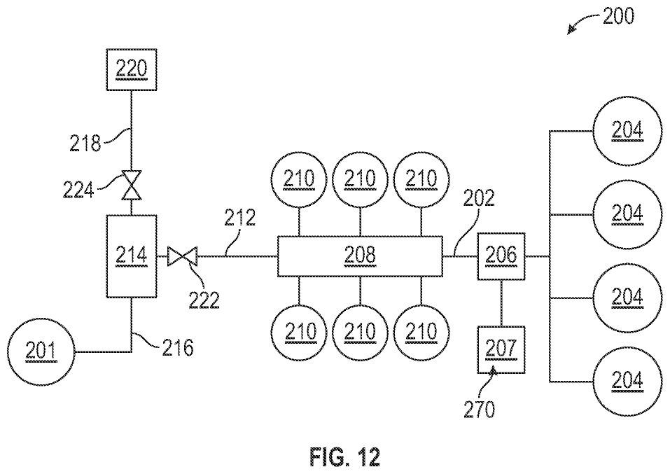

Referring to FIG. 12, one of the well systems 200 of the system 10 of FIG. 1 is shown. While only a single well system 200 is shown in FIG. 12, other well systems 200 of system 10 may be configured similarly as the well system 200 shown in FIG. 12 and described below. In this exemplary embodiment, well system 200 generally includes a fluid supply manifold 202, a plurality of fluid storage tanks 204, a mixing unit 206, a plurality of high-pressure pumps 210, a frac tree 214, a wellhead 216 fluidically connected to a well 201, and a flowback tank 220. Storage tanks 204 and units 208 and 206 are in series fluid communication with conduit 202. Fluid storage tanks 204 of well system 200 store a base fluid (e.g., water) that is routable from the fluid storage tanks 204 to the mixing unit 206 of well system 200. Mixing unit 206 is configured to mix the base fluid supplied by fluid storage tanks 204 with predetermined quantities of fluid additives and unwashed silica frac sand 270 supplied by sand plant 100. The unwashed frac sand 270 may be temporarily stored in a storage container 207 of well system 200 after being received from the sand plant 100. In some embodiments, mixing unit 206 may mix the base fluid with a friction reducer along with the unwashed frac sand 270 from sand plant 100. In other embodiments, mixing unit 206 may mix the base fluid with only the unwashed frac sand 270 without any other additives. In this exemplary embodiment, mixing unit 206 is not configured to add any man-made proppant to the base fluid, and the only proppant or other diverting agent added to the base fluid by mixing unit 206 is the unwashed frac sand 270 supplied by sand plant 100.

In this exemplary embodiment, following mixing in the mixing unit 206, the mixed hydraulic fracturing fluid containing the unwashed frac sand 270 is supplied to a fracturing manifold 208 of well system 200. Particularly, the fracturing fluid is routed through fracturing manifold 208 to the plurality of pumps 210 whereby the fracturing fluid is pressurized to a predetermined fracturing pressure sufficient to initiate or form one or more fractures in the subterranean earthen formation through which well 201 extends. In this exemplary embodiment, each pump 210 comprises a positive displacement pump powered by a power source such as a diesel engine, a gas turbine, and/or other types of pumps known in the art. Accordingly, shutting down or de-energizing the power source of each pump 210 holds each pump 210 stationary such that back pressure may be held within the well 201.

Following pressurization of the fracturing fluid in pumps 210, the fracturing fluid is routed from manifold 208 through a high-pressure fracturing line 212 into the frac tree 214 of well system 200. In this configuration, high pressure fracturing line 212 extends between and provides fluid communication between manifold 208 and frac tree 214. Frac tree 214 is configured to manage the flow and communication of fluid between well 201 and the components (e.g., high pressure fracturing line 212, etc.) of well system 200.

In this exemplary embodiment, frac tree 214 comprises a flow cross and is coupled with high pressure fracturing line 212, a flowback line 218, and wellhead 216. Fluid communication between frac tree 214 and well 201 is provided by wellhead 216 which is disposed at the upper end of well 201 (at the surface). Wellhead 216 provides physical support for frac tree 214 as well as components of well system 200 that extend into well 201, including a casing string (not shown in FIG. 12). The casing string provides structural support to well 201 and controls fluid communication between well 201 and the surrounding earthen formation 203 through which well 201 extends. Although well 201 is a cased well in this embodiment, in general, well system 200 can be used in connection with cased or uncased wells.

In this exemplary embodiment, pressurized fracturing fluid is communicated from high pressure fracturing line 212, through frac tree 214, and into well 201 via wellhead 216. As will be discussed further herein, hydraulic well system 200 also receives and routes flowback fluid from well 201 following the injection of pressurized fracturing fluid into well 201. Particularly, flowback fluid from well 201 is routed through wellhead 216, frac tree 214, and into flowback tank 220 via flowback line 218 for storage in tank 220. In this exemplary embodiment, frac tree 214 includes a frac valve 222 for isolating high pressure fracturing line 212 when flowback fluid is flowed from well 201 into flowback tank 220 via flowback line 218. Additionally, frac tree 214 includes a flowback valve 224 for isolating flowback tank 220 when high pressure fracturing fluid is pumped into well 201 from high pressure fracturing line 212.

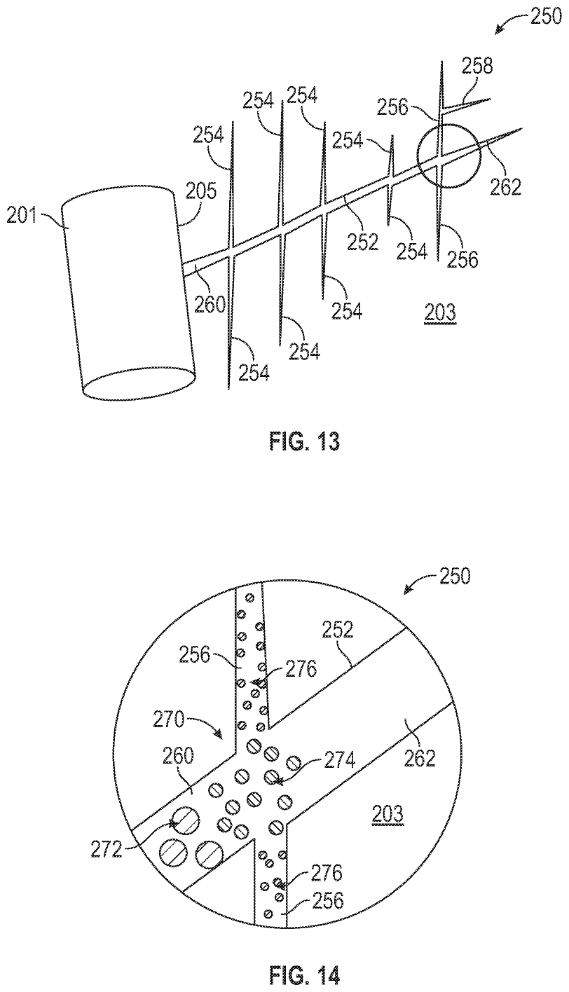

Now referring to FIGS. 12-14, in some embodiments, well system 200 may be employed to form a fracture system 250 shown schematically in FIGS. 13, 14 by hydraulically fracturing a subterranean earthen formation 203 through well 201 extends by injecting the pressurized fracturing of well system 200, including the unwashed frac sand 270 provided by sand plant 100, into well 201. Particularly, FIGS. 13, 14 schematically illustrate a subsurface portion of well and a surrounding subterranean earthen formation 203 through which well 201 extends. In this exemplary embodiment, the fracture system 250 formed by well system 200 generally includes a primary fracture 252 extending from a wall 205 of the well 201, a plurality of near-field secondary fractures 254, a plurality of far-field secondary fractures 256, and a far-field tertiary fracture 258. Additionally, primary fracture 252 includes a near-field portion or segment 260 extending from the wall 205 of well 201 and a far-field portion or segment 262 extending from the near-field segment 260.

Primary fractures 252 of fracture system 250 comprises the initial hydraulic (i.e., not natural) fracture formed in subterranean formation 203 during a well stimulation or hydraulic fracturing operation performed by the well 200 shown in FIG. 12. Primary fracture 252 may extend along one of the natural joints formed in earthen formation 203, where the natural joint presents a point of weakness in formation 203 that intersects the wall 205 of well 201, thereby allowing for the initiation and formation of primary fracture 252 therethrough. Primary fracture 252 of fracture system 250 may only intersect a single natural joint of earthen formation 203, limiting communication between primary fracture 252 and other natural joints of formation 203. Due in at least part to this limited communication or connectivity between primary fracture 252 and multiple natural joints of formation 203, fracture systems including only linear, primary fractures may only provide a limited or temporary increase in hydrocarbon production following a hydraulic fracturing operation.

In addition to primary fracture 252, fracture system 250 includes secondary fractures 254, 256 that extend at a non-zero angle from primary fracture 252. In this exemplary embodiment, secondary fractures 254, 256 extend substantially perpendicular from primary fracture 252. In addition to extending at a non-zero angle from primary fracture 252, secondary fractures 254, 256 may also have a smaller width or diameter than the primary fracture 252. Further, primary fracture 252 may decrease in width or diameter as it extends from well 201, and thus the near-field segment 260 of primary fracture 252 may have a greater width or diameter than the far-field segment 262 of primary fracture 252. In this exemplary embodiment, the branching of secondary fractures 254, 256 from primary fracture 252 forms a dendritic fracture system. In this configuration, secondary fractures 254, 256 may extend across multiple natural joints of earthen formation 203, thereby establishing direct fluid communication between a plurality of the natural joints of formation 203 and well 201. The intersection of secondary fractures 254, 256 with multiple natural joints of earthen formation 203 may substantially increase the drainage area of well 201 and allow for enhanced recovery of hydrocarbons from formation 203.

Fracture system 250 further includes tertiary fracture 256, which extends at a non-zero angle from one of the far-field secondary fractures 256. In this exemplary embodiment, tertiary fracture 256 extends substantially perpendicular from one of the far-field secondary fractures 254. Tertiary fracture 256 may extend along a different natural joint of the earthen formation 203 than which primary fracture 252 extends, further enhancing fluid connectivity between the well 201 and earthen formation 203. Although fracture system 250 is shown in FIGS. 13, 14 as comprising a single primary fracture 252 with a plurality of near-field secondary fractures 254, far-field secondary fractures 256, and a single far-field tertiary fracture 258, in other embodiments, the configuration of fracture system 250 formed by a hydraulic fracturing operation performed by well system 200 may vary in configuration. For instance, in other embodiments, fracture system 250 may comprise a plurality of primary fractures, a primary of near-field tertiary fractures, and/or a plurality of far-field tertiary fractures.

As described above, the unwashed frac sand 270 included in the fracturing fluid injected into formation 203 has a broad distribution of grain sizes. For example, FIG. 14 illustrates unwashed frac sand 270 comprising a first plurality of grains 272, a second plurality of grains 274, and a third plurality of grains 276 each shown schematically in FIG. 14. The first plurality of grains 272 have an average grain size larger than an average grain size of the second plurality of grains 274. Additionally, the second plurality of grains 274 have an average grain size larger than an average grain size of the third plurality of grains 276. In some embodiments, the first plurality of grains 272 of unwashed frac sand 270 has an average grain size of approximately 300 μm, the second plurality of grains 274 of unwashed frac sand 270 has an average grain size of approximately 150 μm, and the third plurality of grains 276 of unwashed frac sand 270 has an average grain size of approximately 90 μm.

Different sized grains of unwashed frac sand 270 are not distributed uniformly within the fracture network 250 formed in earthen formation 203. Instead, relatively smaller grains (e.g., the third plurality of grains 276) of unwashed frac sand 270 are generally transported deeper into fracture network 250 prior to settling therein than relatively larger grains (e.g., the first plurality of grains 272). As an example, the first plurality of grains 272 of unwashed frac sand 270 may generally settle or be deposited within the near-field segment 260 of primary fracture 252 while the second plurality of grains 274 of unwashed sand may generally penetrate into the far-field segment 262 of primary fracture 252 in this example.

Additionally, the third plurality of grains 276, being smaller in average grain size than either of the pluralities of grains 272, 274, may penetrate into far-field secondary fractures 256 prior to settling. The relatively larger pluralities of grains 272, 274 may be impeded from penetrating deeply into the fracture network 250, limiting the ability of grains 272, 274 to prop open or maintain fluid conductivity through the far-field features of fracture network 250. Conversely, the third plurality of grains tend to penetrate relatively deeper into fracture network 250 than grains 272, 274 prior to settling, allowing the third plurality of grains 276 to prop open and maintain fluid conductivity through the far-field features of fracture network 250 such as far-field secondary fracture 256 and far-field tertiary fractures 258. To state in other words, unwashed frac sand 270 has a broad grain-size distribution compared to washed frac sand. Due to the relative ease of transporting smaller grains compared to larger grains, grains of the unwashed frac sand 270 tend to longitudinally fractionate in order of decreasing grain size within fracture network 250 whereby relatively larger grains (e.g., first plurality of grains 272), tend to congregate or settle within the near-field segment 260 of fracture network 250, whereas the relatively smaller grains (e.g., third plurality of grains 276), including the clays, silts, and other fine particles, tend to congregate or settle within the far-field areas of fracture network 250. The fractionation of frac sand within a fracture network by grain size has been demonstrated by experimental studies discussed below.

Given that the relatively small grains of unwashed frac sand 270, including clay minerals thereof, tend to penetrate deeper into the fracture network 250 than the relatively larger grains of unwashed frac sand 270, they do not screen out or otherwise obstruct fluid conductivity through the fracture network 250, such as through the near-field segment 260 of primary fracture 252, to an intolerable degree making hydrocarbon production from the fractured well uneconomical. Instead, the fractionation of the grains of unwashed frac sand 270 within fracture network 250 based on their grain size prevents the accumulation of relatively smaller grains, including clays, silts, and other fine particles, from screening out the fracture network 250, including the near-field segment 260 of primary fracture 252. This fractionation process also provides a means to prop open relatively narrow fractures in the distal fracture field (e.g., far-field tertiary fracture 258) using relatively small grains (e.g., third plurality of grains 276). The propping open of narrow far-field fractures using small grains of unwashed frac sand 270 may allow for more effective stimulation of well 201 and formation 203 than would otherwise be possible using washed frac sand given that washed frac sand generally lacks fine particles capable of fitting within the narrowest fractures.

Although the fractionation process discussed above results in a general longitudinal decrease in grain size in the frac field, small fractions of the finer particles 276, may be locally dispersed between larger grains 274 and 272 in more proximal reaches of the induced fracture 260. This elevated presence of clays, silts, and other fine particles or grains 276, as well as coarser grains 272 in unwashed frac sand 270 may initially hinder fluid conductivity between well 201 and formation 203, although not to an intolerable or uneconomical degree. Whereas initial conductivity may be hindered, the elevated presence of clays, silts, and other fine particles in unwashed frac sand 270 may actually minimize the long-term loss in fluid conductivity between well 201 and formation 203 that occurs during production following the hydraulic fracturing of formation 203. Frac sand, may create dune-like accumulations of sand in the fracture network, however dunes composed of unwashed frac sand may be more stable than those composed of washed sand due to the small clays, silts, and other finer grains 276 intermixed with large particles 270 in proximal fractures 260. The stabilization is due to the cohesive properties that particles smaller than 100 microns possess. The fine particles operate to bind the mixture of larger grains 272 and 274 together resulting in dunes that are steeper, larger and more stable than those composed of washed sand.

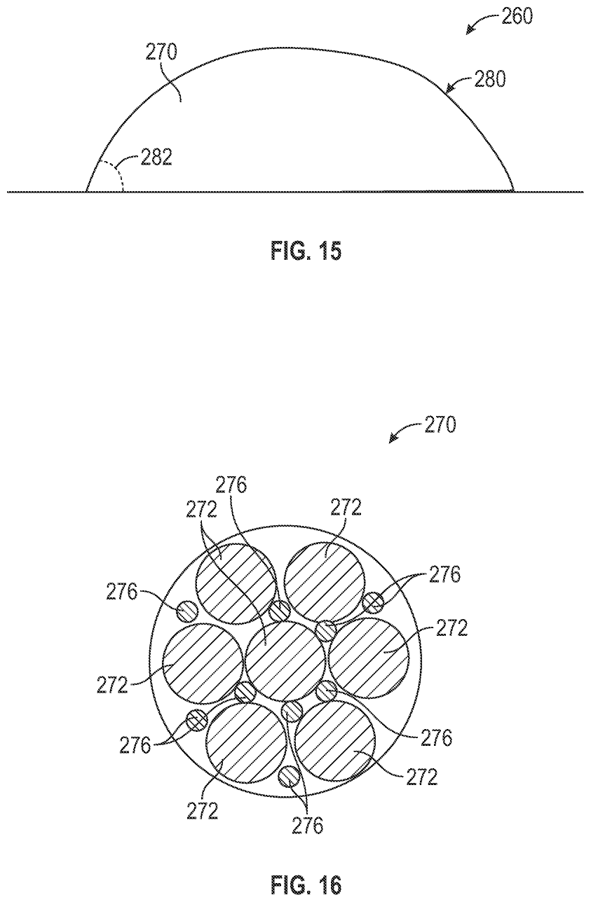

Referring to FIGS. 15, 16, a schematic cross-section of an exemplary dune or dune-like accumulation 280 of unwashed frac sand 270 deposited in the near-field segment 260 of primary fracture 252 is shown. The proximal fracture 260 may contain a steep slip face 282 that exceeds the angle of repose associated with cohesionless grains such as those commonly contained in washed frac sand. As shown particularly in FIG. 16 which is a magnified view of a portion of dune 280, the dune 280 is stabilized by the added cohesion from finer grains 276 operating to bind the larger grains 272 together. Dune 280 may not only be steeper due to the added interparticle cohesion, but they may be more difficult to erode. Particularly, the stability added by the clays, silts, and other fine particles requires a greater amount of shear stress to erode the grain mixture than cohesionless sediment associated with washed frac sand. This may reduce the amount of sediment produced from well 201 during the flowback and production stages of the well 201, meaning that the emplaced unwashed frac sand 270 props open the fracture for a relatively longer duration than comparative washed frac sand. Thus, any potential disadvantage posed by an initial limited fluid conductivity provided by the unwashed frac sand 270 may be minimized over the lifespan of the well as unwashed frac sand 270 may perform better in maintaining the initial fluid conductivity provided by the hydraulic fracturing operation than similar but washed frac sands. Additionally, the finer grains 276 in the unwashed frac sand 270, due to their low settling velocities, may act to increase the effective density of the fracturing fluid thereby increasing the sediment transport efficiency of sand 270 within the fracture network. The increase in cohesion and resistance to erosion exhibited by unwashed frac sand has been demonstrated by experimental studies discussed below.

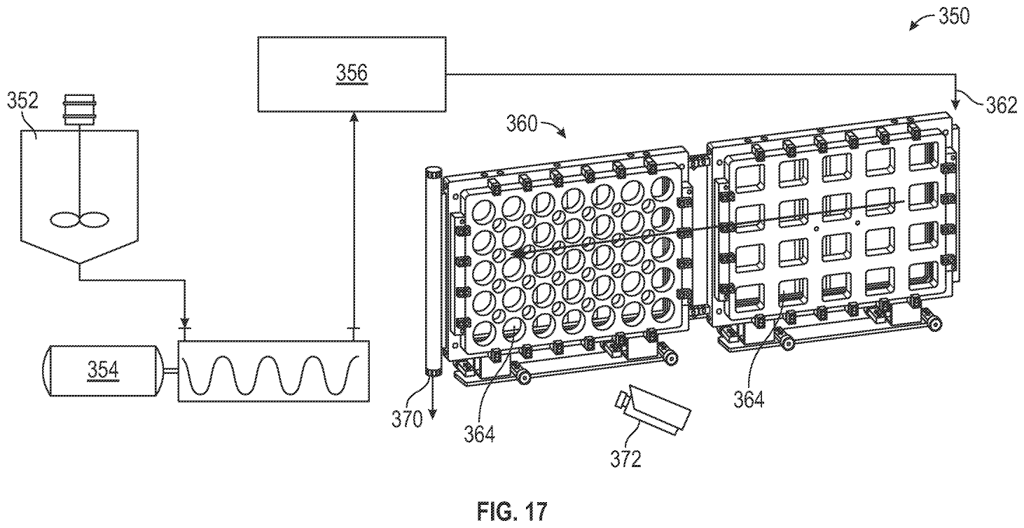

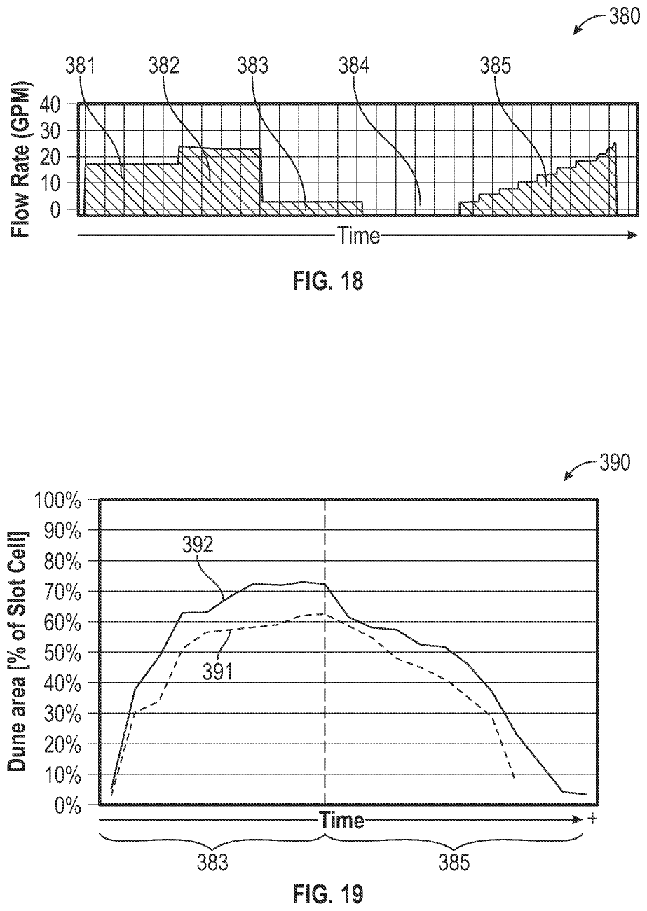

Referring to FIGS. 17, 18, experiments were conducted to examine the properties of unwashed frac sand within a simulated hydraulic fracture. Particularly, an apparatus 350 (shown in FIG. 17) was used to examine the behavior of unwashed frac sand emplaced in a simulated hydraulic fracture. Apparatus 350 included a mixing tank 352, a pump 354, a sensor package 356 including flowrate and density sensors, a slot cell assembly 360, and a camera 372. Mixing tank 352 mixed unwashed frac sand with water and a friction reducer to form a hydraulic fracturing fluid comprising the unwashed frac sand. Pump 354 pumped the fracturing fluid produced by mixing tank 352 to an inlet 362 of the slot cell assembly 360. The fracturing fluid percolated through the slot cell assembly 360, eventually exiting the slot cell assembly 360 at a discharge 370. Slot cell assembly 360 was placed within the field of view of camera 372 so that images of the fracturing fluid and the unwashed frac sand contained therein could be captured by camera 372. Slot cell assembly 360 of apparatus 350 generally included a pair of generally rectangular slot cells 364 each defined by clear (e.g., Plexiglas™) vertical walls and extending approximately 22″ in height, approximately in 30″ in length, and approximately 1/16″ in width.

As shown particularly in a graph 380 illustrated in FIG. 18, in an experiment, the fracturing fluid containing the unwashed frac sand was transported through apparatus 350 in a plurality of distinct stages. Particularly, in a first stage 381, a dye was mixed with water and friction reducer to form a dyed slickwater which would be visually distinguishable to the camera 372. In a second stage 382, the dyed slickwater was mixed with unwashed frac sand to form the hydraulic fracturing fluid. In a third stage 383, the fracturing fluid was delivered to the slot cell assembly 360 at a relatively low flowrate whereby a dune comprising the unwashed frac sand would be formed or deposited in the slot cell assembly 360. In a fourth stage 384, the slot cell assembly 360 was shut-in and the flowrate of the fracturing fluid was reduced to zero to allow unwashed frac sand suspended in the fracturing fluid to settle within the slot cell assembly 360. In a fifth stage 385, the flowrate was gradually increased in a step-wise manner to gradually erode the dune of unwashed frac sand formed within the slot cell assembly 360.

The stages 381-385 illustrated in graph 380 were performed for a plurality of different unwashed frac sands and the results with respect to dune area, dune height, flow velocity, etc., were captured by camera 372 and sensor package 356 for analysis. Referring now to FIGS. 19-23, some of the results produced from experiments performed using the apparatus 350 of FIG. 17 are shown in FIGS. 19-23. Particularly, FIG. 19 illustrates a graph 390 including dune area (as a percentage of one of the slot cells 364 of slot cell assembly 360) as a function of time during the third stage 383 and fifth stage 385 portions of the experiment. Graph 390 illustrates the dune area corresponding to the washed (line 391 of graph 390) and the unwashed variants (line 392 of graph 390) of the Frac Sand 3 identified in Table 1 above. Graph 390 illustrates that the unwashed variant of Frac Sand 3 deposited in the slot cell assembly 360 more rapidly, built a relatively larger dune, and eroded more slowly from the slot cell assembly 360 than the washed variant of Frac Sand 3. Particularly, the experiments conducting using apparatus 350 indicated that the unwashed variant of Frac Sand 3 formed a dune having a steeper slip face than the washed variant of Frac Sand 3. The Experiments also indicated that the greater degree of cohesive clays found in the unwashed variant of Frac Sand 3 led to the creation of more stable dune. The more stable dune created by the unwashed variant of Frac Sand 3 may lead to reduced sediment flowback during the production stage of a given well fractured using the unwashed variant.

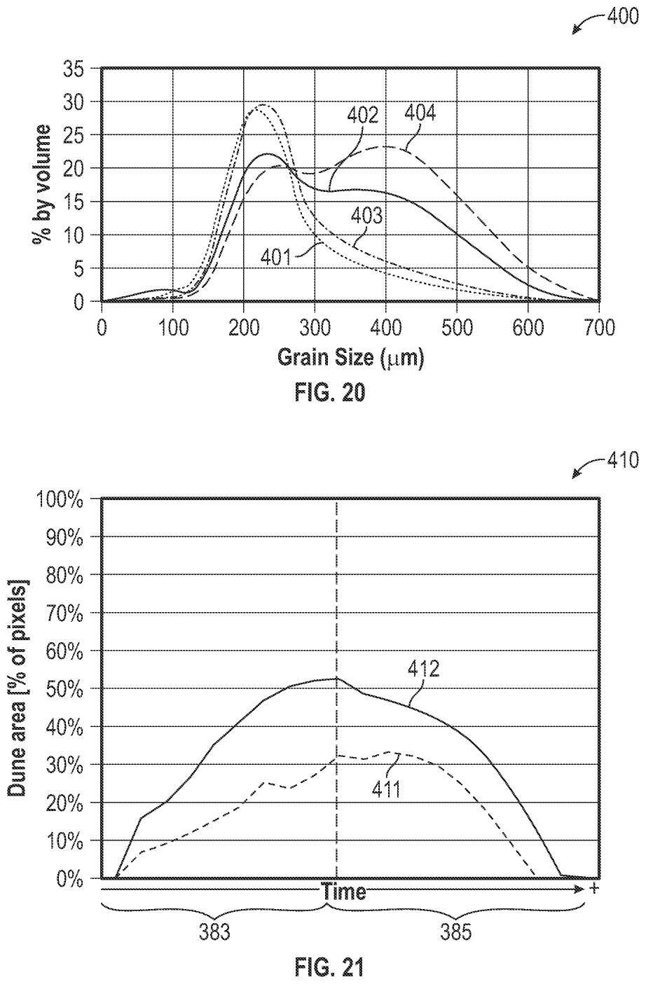

FIG. 20 illustrates a grain-size distribution graph 400 including particle percentage by volume as a function of grain size in μm. Particularly, graph 400 indicates the grain size distribution for a washed Frac Sand 3 input 401, an unwashed Frac Sand 3 input 402, a washed Frac Sand 3 deposit 403, and an unwashed Frac Sand 3 deposit 404. Thus, graph 400 indicates the grain size distribution of the washed and unwashed variants of Frac Sand 3 inputted to the slot cell assembly 360, and the normalized grain size distribution of the washed and unwashed variants of Frac Sand 3 deposited during the third stage 383 of the experiments in which fracturing fluids comprising washed (in a first experiment) and unwashed (in a separate, second experiment) were supplied to slot cell assembly 360. Graph 400 indicates that the unwashed Frac Sand 3 deposit 404 were not sorted (i.e., sorted by grainsize/settling velocity) and instead were deposited from frictional freezing. Additionally, graph 400 indicates that fewer fine grained particles of both the washed Frac Sand 3 input 401 and the unwashed Frac Sand 3 input 402 were deposited within slot cell assembly 360 as washed Frac Sand 3 deposit 403 and unwashed Frac Sand 3 deposit 404, respectively, indicating that smaller particles of a given frac sand tend to travel farther through a fracture network before depositing therein.

FIG. 21 illustrates another graph 410 including dune area (as a percentage of one of the slot cells 364 of slot cell assembly 360) as a function of time during the third stage 383 and fifth stage 385 portions of the experiment. Particularly, graph 410 illustrates the dune area corresponding to a washed (line 411 of graph 410) variant and an unwashed variant (line 412 of graph 410) of another type of frac sand (Frac Sand 4) different from the Frac Sands 1, 2, and 3 identified in Table 1 above. However, as with the Frac Sand 3 variants shown in graph 390 of FIG. 19, graph 410 illustrates that the unwashed variant of Frac Sand 4 deposited in the slot cell assembly 360 more rapidly, built a relatively larger dune, and eroded more slowly from the slot cell assembly 360 than the washed variant of Frac Sand 4.

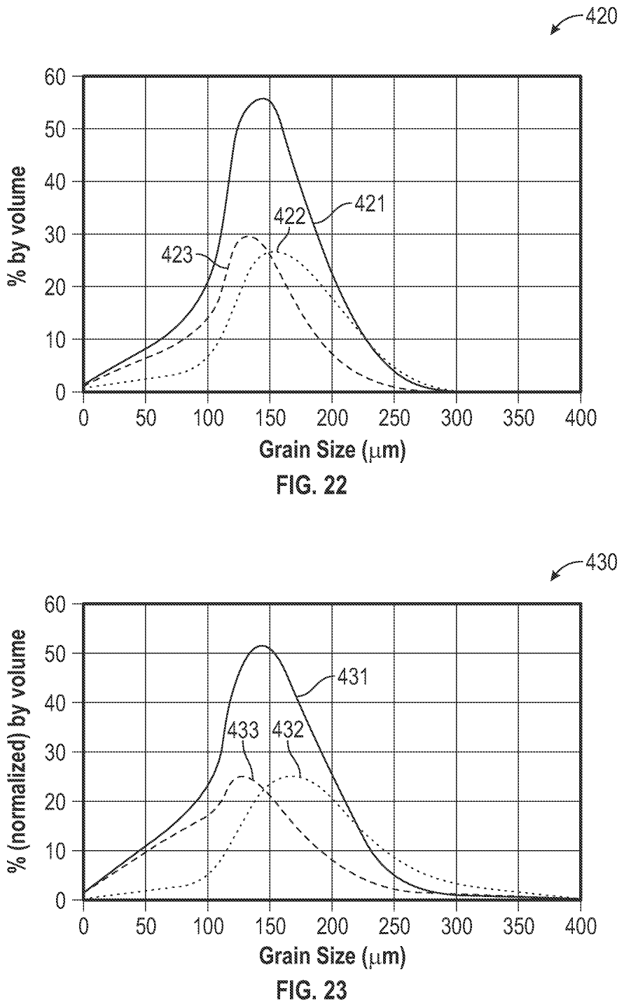

FIG. 22 illustrates a grain-size distribution graph 420 including particle percentage by volume as a function of grain size in μm. Particularly, graph 420 indicates the normalized grain size distribution for an unwashed Frac Sand 4 input 421, grain-size distributions of unwashed Frac Sand 4 deposit 422, and an unwashed Frac Sand 4 output 423. Unwashed Frac Sand 4 input 421 corresponds to the grain size distribution of the unwashed Frac Sand 4 as it was pumped into slot cell assembly 360. Unwashed Frac Sand 4 deposit 422 corresponds to the grain size distribution of the unwashed Frac Sand 4 which was deposited within slot cell assembly 360. Unwashed Frac Sand 4 out 423 corresponds to the grain size distribution of the unwashed Frac Sand 4 which did not deposit within slot cell assembly 360 and instead continued to the discharge 370 thereof. As shown in graph 420, the unwashed Frac Sand 4 output 423 has a significantly greater degree of small particles compared to the unwashed Frac Sand 4 deposit 422, providing further evidence that smaller particles tend to travel farther through a given fracture network prior to being deposited therein.

FIG. 23 illustrates another a grain-size distribution graph 430 including particle percentage by volume as a function of grain size in μm. The unwashed frac sand pertaining to graph 430 comprises another type of unwashed frac sand (Frac Sand 5) which was pumped through apparatus 350 as part of the experiments conducted using apparatus 350. Particularly, graph 430 indicates the normalized grain-size distribution for an unwashed Frac Sand 5 input 431, grain-size distributions of unwashed Frac Sand 5 deposit 432, and an unwashed Frac Sand 5 output 433. Unwashed Frac Sand 5 input 431 corresponds to the grain size distribution of the unwashed Frac Sand 5 as it was pumped into slot cell assembly 360. Unwashed Frac Sand 5 deposit 432 corresponds to the grain size distribution of the unwashed Frac Sand 5 which was deposited within slot cell assembly 360. Graph 430 provides further proof that finer particles tend to penetrate deeper into a given fracture network prior to being deposited therein.

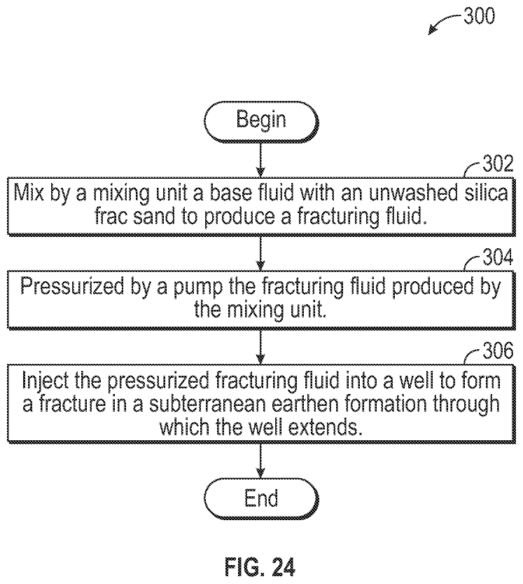

Referring to FIG. 24, an embodiment of a method 300 for forming a fracture in a subterranean earthen formation is shown. Initially at block 302, method 300 comprises mixing by a mixing unit a base fluid with an unwashed silica frac sand to produce a fracturing fluid. In some embodiments, block 302 comprises mixing a base fluid stored in storage tanks 204 of well system 200 shown in FIG. 3 with unwashed silica frac sand 270 stored in storage container 207 by the mixing unit 206 of system 200. In some embodiments, the fracturing fluid does not include any ceramic or other artificially produced proppants. In certain embodiments, the fracturing fluid may only include water, a friction reducer, and the unwashed frac sand. In other embodiments, the unwashed sand that may be mixed with washed silica sand and the base fluid by the mixing unit to form the fracturing fluid. The unwashed frac sand may be produced from a sand plant in which the frac sand is dried without being first washed. The production of the unwashed frac sand may also include sieving the frac sand such that grains having a small grain size (e.g., less than 200 μm in size) are not sorted out from the unwashed frac sand during the sieving process and instead only grains having a large grain size (e.g., greater than 600 μm or 700 μm, etc., in size) are sorted out from the unwashed frac sand.

At block 304, method 300 comprises pressurizing by a pump the fracturing fluid produced by the mixing unit. In some embodiments, block 304 comprises pressurizing the fracturing fluid comprising unwashed frac sand 270 of well system 200 by the high-pressure pumps 210 of well system 200 shown in FIG. 3. In some embodiments, the fracturing fluid may be pressurized to several thousands of pounds per square inch (PSI) (e.g., between 5,000 PSI and 7,000 PSI, for example). At block 306, method 300 comprises injecting the pressurized fracturing fluid into a well to form a fracture in a subterranean earthen formation through which the well extends. In some embodiments, block 306 comprises injecting the fracturing fluid comprising unwashed frac sand 270 of well system 200 shown in FIG. 3 into well 201 to form a fracture in earthen formation 203. For example, block 306 may comprise forming a fracture network having features in common (e.g., a primary fracture, near-field and/or far-field secondary fractures extending from the primary fracture, and near-field and/or far-field tertiary fractures extending from the secondary fractures) with the fracture network 250 shown in FIGS. 13, 14. The unwashed frac sand present in the fracturing fluid may be deposited in the formed fracture network, where the unwashed frac sand is fractionated within the fracture network with relatively smaller grains tending to penetrate deeper into the fracture network than relatively larger grains of the unwashed frac sand.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

1. A system for stimulating a well extending through a subterranean earthen formation, comprising:
a storage tank comprising a base fluid;
a storage container comprising an unwashed silica frac sand;
a mixing unit in fluid communication with the storage tank, wherein the mixing unit is configured to mix the base fluid from the storage tank with the unwashed silica frac sand from the storage container to produce a fracturing fluid; and
a pump configured to pressurize the fracturing fluid from the mixing unit and inject the fracturing fluid into the well to form a fracture within the earthen formation.

2. The system of claim 1, wherein the unwashed silica frac sand is comprised of between 1.5% and 10% of clay minerals by percent volume.

3. The system of claim 1, wherein a sorting index (ϕ1) of the unwashed silica frac sand is between 0.50ϕ units and 0.80ϕ units.

4. The system of claim 1, wherein the unwashed silica frac sand includes between 300 million and 700 million particles per pound.

5. The system of claim 1, wherein the unwashed silica frac sand is comprised of between 25% and 30% of grains having an American Society for Testing (ASTM) mesh size greater than 141 ASTM mesh.

6. The system of claim 1, wherein the unwashed silica frac sand has a turbidity equal to or greater than 260 Nephelometric Turbidity Units (NTUs).

7. The system of claim 1, wherein the fracturing fluid does not comprise a ceramic proppant.

8. A system for stimulating a well extending through a subterranean earthen formation, comprising:
a storage tank configured to store a base fluid;
a storage container comprising a silica frac sand;
a mixing unit in fluid communication with the storage tank, wherein the mixing unit is configured to mix the base fluid from the storage tank with the silica frac sand from the storage container to produce a fracturing fluid, and wherein the silica frac sand is comprised of between 1.5% and 10% of clay minerals by percent volume; and
a pump configured to pressurize the fracturing fluid from the mixing unit and inject the fracturing fluid into the well to form a fracture within the earthen formation.

9. The system of claim 8, wherein the silica frac sand is unwashed.

10. The system of claim 8, wherein a sorting index (ϕ1) of the silica frac sand is between 0.50ϕ units and 0.80ϕ units.

11. The system of claim 8, wherein the silica frac sand includes between 300 million and 700 million particles per pound.

12. The system of claim 8, wherein the silica frac sand is comprised of between 25% and 30% of grains having an American Society for Testing (ASTM) mesh size greater than 141 ASTM mesh.

13. The system of claim 8, wherein the silica frac sand has a turbidity equal to or greater than 260 Nephelometric Turbidity Units (NTUs).

14. The system of claim 8, wherein the fracturing fluid does not comprise a ceramic proppant.

15. A method for forming a fracture in a subterranean earthen formation, comprising:
(a) mixing by a mixing unit a base fluid with an unwashed silica frac sand to produce a fracturing fluid;
(b) pressurizing by a pump the fracturing fluid produced by the mixing unit; and
(c) injecting the pressurized fracturing fluid into a well extending through the earthen formation to form a fracture within the earthen formation.

16. The method of claim 15, wherein the unwashed silica frac sand is comprised of between 1.5% and 10% of clay minerals by percent volume.

17. The method of claim 15, wherein a sorting index (ϕ1) of the unwashed silica frac sand is between 0.50ϕ units and 0.80ϕ units.

18. The method of claim 15, wherein the unwashed silica frac sand includes between 300 million and 700 million particles per pound.

19. The method of claim 15, wherein the unwashed silica frac sand has a turbidity equal to or greater than 260 Nephelometric Turbidity Units (NTUs).
